(19) United States
(12) Patent Application Publication
(10) Pub. No.: US 2026/0331961 A1
(43) Pub. Date: Oct. 22, 2026

(54) WIRELESS POWER SUPPLY SYSTEM

(71) Applicant: AETERLINK CORP., Tokyo (JP)

(72) Inventors: Tomohiro KUBOUCHI, Tokyo (JP); Naoto KODATE, Tokyo (JP); Yuji TANABE, Tokyo (JP); Tatsuya Masuda, Tokyo (JP)

(21) Appl. No.: 19/563,240

(22) Filed: Mar. 11, 2026

Related U.S. Application Data
(63) Continuation-in-part of application No. PCT/JP2024/028692, filed on Aug. 9, 2024.

(30) Foreign Application Priority Data
Sep. 11, 2023 (JP) 2023-147232

(51) Int. Cl. H02J 50/20; H02J 50/40; H02J 50/80

(52) U.S. Cl. CPC H02J 50/20; H02J 50/40; H02J 50/80

(57) ABSTRACT

To provide a transmitter capable of wirelessly feeding power to at least one receiver through power feeding radio waves The transmitter is capable of executing: a power detection step of detecting transmission power of the power feeding radio waves transmitted from the transmitter; and a power control step of controlling the transmission power so that the transmission power approaches a predetermined value, in a case that the transmission power detected in the power detection step does not match the predetermined value.

### CROSS-REFERENCE TO RELATED APPLICATIONS

This is a continuation of International Application No. PCT/JP2024/028692 filed on Aug. 9, 2024, and claims priority from Japanese Patent Application No. 2023-147232 filed on Sep. 1, 2023, the entire content of which is incorporated herein by reference.

### FIELD OF THE INVENTION

The present technology relates to a wireless power feeding system.

### BACKGROUND

In a conventional technology, it has been known that electric power can be transmitted by radio transmission.

Patent Literature 1 discloses a technique for controlling only a power transmitting device based on only information which can be obtained by the power transmitting device, in order to supply voltages to a load device.

### PRIOR ART DOCUMENTS

[Patent Document 1] Japanese Unexamined Patent Application Publication No. 2020-114110

### SUMMARY OF THE INVENTION

### Problem to be Solved by the Invention

However, there are cases that sufficient power for functioning a receiver may not be transmitted to the receiver.

Therefore, the present disclosure has been made to solve the above-mentioned problem, and its purpose is to provide a technique for transmitting sufficient power for functioning a receiver, to the receiver.

### Means for Solving the Problem

A transmitter capable of wirelessly feeding power to at least one receiver through power feeding radio waves is provided. The transmitter is capable of executing: a step of detecting power for detecting transmission power of the power feeding radio waves which are transmitted from the transmitter; and a step of controlling power for controlling the transmission power so that the transmission power reaches a predetermined value in a case that the transmission power detected at the step of detecting power does not match the predetermined value,

### Effects of the Invention

According to the present technique, it is possible to transmit sufficient power for functioning a receiver, to the receiver.

### BRIEF DESCRIPTION OF THE DRAWINGS

FIG. 1 illustrates a an entire WPT system 1 according to the present embodiment.

FIG. 2 is a block diagram illustrating an example of the configuration of a transmitter 100 and a receiver 200 illustrated.

FIG. 3 is a block diagram illustrating an example of the configuration of the transmitter 100 (first embodiment).

FIG. 4 is a block diagram illustrating an example of the configuration of the transmitter 100 (second embodiment).

FIG. 5 is a diagram illustrating an example configuration of a transmission system according to a modification of the present invention.

### DESCRIPTION OF THE PREFERRED EMBODIMENTS

Hereinafter, embodiments of the present disclosure will be described with referring to the figures. In all figures describing the embodiments, for the same configuration elements, the same reference signs are given, and duplicated explanations are omitted. The below-mentioned embodiments shall not unduly restrict the present disclosure described in the claims. In addition, not all configuration elements illustrated in the embodiments are necessarily essential configuration elements of the present disclosure. Further, each figure is a schematic diagram and is not necessarily strictly illustrated.

### Outline

### 1 Configuration Diagram of Entire System

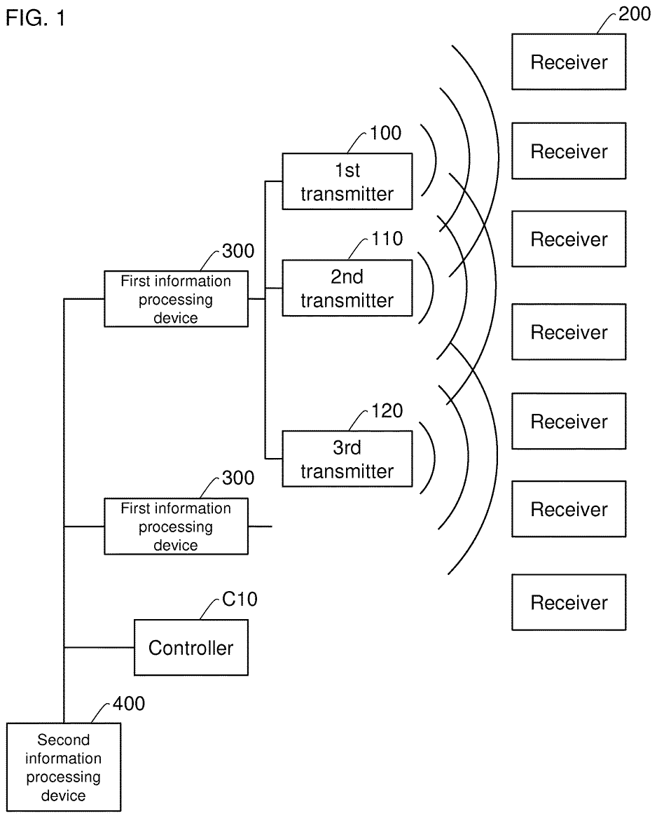

FIG. 1 illustrates a configuration diagram of an entire wireless power feeding system or wireless power transferring system (hereinafter, it is abbreviated to WPT system) 1 according to the present embodiment.

The WPT system 1 illustrated in FIG. 1 includes, for example, transmitters 100, receivers 200, first information processing devices 300, and a second information processing device 400. The WPT system 1 illustrated in FIG. 1 is configured to be used, for example, in a building or a factory. The type of connection established between the transmitter 100 and the first information processing device 300 and the type of the connection established between the first information processing device 300 and the second information processing device 400 can be wired connection or wireless connection.

FIG. 1 illustrates one example in which three pieces of transmitters 100 are included in the WPT system 1, but the number of the transmitters 100 to be included in the WPT system 1 is not limited to three. The number of the transmitters 100 to be included in the WPT system 1 may be two or less, alternatively, it may be four or more.

FIG. 1 illustrates one example in which seven pieces of receivers 200 are included in the WPT system 1, but the number of the receivers 200 to be included in the WPT system 1 is not limited to seven. The number of the receivers 200 to be included in the WPT system 1 may be six or less, alternatively, it may be eight or more.

The transmitter 100 is capable of wirelessly supplying electric power to the receiver 200 via power feeding radio waves (or radio waves for feeding power).

Such power feeding radio waves to be transmitted from the transmitter 100 can be regarded as radio waves composed of substantially continuous waves.

The power feeding signals to be transmitted from the transmitter 100 are radio frequency signals having a predetermined power. Preferably, such power feeding signals can be regarded as substantially continuous waves though having pause periods which are arbitrary short periods (for example, 50 milliseconds) as compared with periods other than the pause periods (for example, 4 seconds).

In one example, the power feeding signals (or power feeding radio waves) to be transmitted from the transmitter 100 may be continuous waves (CW) having a predetermined electric power. Also, in one example, the frequency band of the power feeding signals is set to be a frequency band of 920 MHz, considering a distance between the transmitter 100 and the receiver 200. In a case of frequency band set to be higher than the exemplified frequency band, there is a possibility that a predetermined power for operating the receiver 200 may not be supplied as long as the distance between the transmitter 100 and the receiver 200 is not shortened. Therefore, appropriate frequency bands may be set by considering the practical use range (in one example, the distance between the transmitter 100 and the receiver 200 is made to be several meters),

In the present disclosure, the frequencies of the radio waves transmitted from the transmitter 100 differ from each other centering on the frequency band of 920 MHz.

In some cases, a restriction may be imposed to intermittently transmit power feeding signals having predetermined electric power, by the legislation of a country where the WPT system 1 is installed. In one example, when power feeding signals transmitted from the transmitter 100 fall under the provisions of radio stations prescribed in the Radio Act of Japan, it may be necessary to provide certain pause periods to the power feeding signals, according to the Radio Act (regardless of qualifications). In this case, considering a certain degree of continuity on a time axis, it cannot be said that the power feeding signals are continuous waves. However, it is important that pause periods having very little time are provided, and thus it is still possible to regard the power feeding signals to be transmitted from the transmitter 100 as substantially continuous waves. The ratio between the duration of the power feeding signals and the pause period may be set arbitrary as long as the power feeding signals transmitted from the transmitter 100 can be regarded as substantially continuous waves as described above. In one example, the duration of the pause period is approximately in a range of from about 1/50 to 1/100 of the duration of the power feeding signals.

It is preferable that the power feeding radio waves to be transmitted from the transmitter 100 are made to be unmodulated radio waves with no modulation signal and no information.

Specifically, there are types of radio emissions for representing characteristics of radio waves to be used in communication system, in general. The types of radio emissions can be represented by a three-character string consisting of alphabets and a numerical value, for indicating the type of modulation of main carrier wave, the type of signal for modulating main carrier wave, and type of transmitted information.

The type of modulation of main carrier wave is selected from a group comprising: N (unmodulated), A (amplitude modulation, double-sideband), H (amplitude modulation, single-sideband with full carrier), R (amplitude modulation, single-sideband with reduced carrier), J (amplitude modulation, single-sideband with suppressed carrier), B (amplitude modulation, independent sideband), C (amplitude modulation, independent sideband), F (angle modulation, frequency modulation), G (angle modulation, phase modulation), and D (modulation of performing amplitude modulation and angle modulation simultaneously or in certain order).

The type of signal for modulating main carrier wave is selected from a group comprising: 0 (no modulating signal), 1 (one channel containing digital information, no subcarrier), 2 (one channel containing digital information, using a subcarrier), 3 (one channel containing analog information), 7 (more than one channel containing digital information), 8 (more than one channel containing analog information), and 9 (combination of more than one channel containing analog information and more than one channel containing digital channel).

The type of transmitted information is selected from a group comprising: N (no transmitted information), A (telegraphy, intended to be decoded by ear), B (telegraphy, intended to be decoded by machine), C (Facsimile), D (Data transmission, telemetry or telecommand (remote control)), E (Telephony), F (Video (television signals)), and W (Combination of any of the above (from N to F)).

In the present embodiment, the type of radio emission of power feeding radio waves is set to be “NON”, wherein “N” indicates the “unmodulated”, “0” indicates the “one channel containing digital information, no subcarrier”, and “N” indicates the “no transmitted information”. This indicates that, in the power feeding radio waves, the main carrier is not subjected to modulation (unmodulated), contains no digital signal (one channel containing digital information, no subcarrier), and contains no transmitted information (no information).

Thus, it is possible to stably transmit energy, since it is not subjected to modulation, and interference with other communication systems present in the surroundings can be reduced. In addition, since it is not subjected to modulation, the transmission energy focus on carrier waves. As a result, it is possible to efficiently transmit energy between the transmitter and the receiver. Since no information is transmitted, the system can be configured to be simple, and the design and implementation of the transmitter and receiver can be simplified.

In the present specification, the transmitter 100 is defined as a device 100 capable of transmitting electric power in a sense of wirelessly transmitting electric power. And similarly, the receiver 200 is defined as a device 200 capable of receiving electric power in a sense of wirelessly receiving electric power. As will be described later, the receiver 200 may transmit, to the transmitter 100, for example, information on conditions of the receiver 200 or information on measurement results of a sensor, as data signals (communication radio waves), and the transmitter 100 may receive such data signals. In this case, the transmitter 100 functions as a receiver capable of receiving data signals, and the receiver 200 functions as a transmitter capable of transmitting data signals.

FIG. 1 illustrates one example in which two pieces of first information processing devices 300 are included in the WPT system 1, but the number of the first information processing devices 300 to be included in the WPT system 1 is not limited to two. The number of the first information processing devices 300 to be included in the WPT system 1 may be one, alternatively, it may be three or more.

For example, the transmitter 100 transmits power feeding signals or data signals to the receiver 200. For example, the transmitter 100 transmits, to the receiver 200, power feeding signals using radio waves of a frequency band of 920 MHz. For example, the transmitter 100 transmits, to the receiver 200, data signals using radio waves of a frequency band of 2.4 GHz. However, the transmitter 100 may transmit data signals using radio waves of a frequency band of 920 MHz

For example, the transmitter 100 may feed power to one receiver 200, or may feed power to a plurality of receivers 200. For example, the transmitter 100 may transmit data signals to one receiver 200, or may transmit data signals to a plurality of receivers 200. For example, the transmitter 100 may transmit data signals similar to those of other transmitters 100 or may transmit data signals different from those of other transmitters 100. For example, the transmitter 100 may transmit predetermined command signals as the data signals to the receiver 200 or may transmit preset signals as the data signals to the receiver 200.

For example, the transmitter 100 receives data signals which are transmitted from the receiver 200. For example, the transmitter 100 may receive data signals transmitted from a single receiver 200 or may receive data signals transmitted from a plurality of receivers 200. The transmitter 100 transmits data signals transmitted from the receiver 200 to the first information processing device 300. The transmitter 100 transmits information on conditions of the transmitter 100 to the first information processing device 300.

For example, the receiver 200 receives power feeding signals or data signals which are transmitted from the transmitter 100. For example, in a case that the receiver 200 includes a power storage part, the receiver 200 converts power feeding signals transmitted from the transmitter 100 into electric power, and stores the converted electric power in the power storage part. For example, in a case that the receiver 200 includes a predetermined sensor, the receiver 200 converts power feeding signals transmitted from the transmitter 100 into electric power and drives the sensor with the converted electric power.

For example, the receiver 200 transmits information on conditions of the receiver 200 or information on measurement results of a sensor, to the transmitter 100, as data signals.

The first information processing device 300 is a device for processing information capable of monitoring operations of the transmitter 100 and receiver 200 included in the WPT system 1. For example, the first information processing device 300 determines whether the transmitter 100 or receiver 200 is in a preset condition based on information relating to conditions of the transmitter 100 and receiver 200, transmitted from the transmitter 100. When determining that it becomes in a preset condition, the first information processing device 300 transmits predetermined information to the second information processing device 400.

Additionally, the first information processing device 300 stores information relating to the transmitter 100 and receiver 200 included in the WPT system 1. For example, the first information processing device 300 stores information relating to conditions of the transmitter 100 and receiver 200, transmitted from the transmitter 100, in the storage part provided in the first information processing device 300.

Additionally, the first information processing device 300 controls operations of the transmitter 100 included in the WPT system 1. For example, the first information processing device 300 transmits predetermined instructions or information to the transmitter 100.

Additionally, the first information processing device 300 controls operations of the second information processing device 400.

For example, the second information processing device 400 is a device for processing information, to be operated by an administrator of the WPT system 1. When receiving, from the first information processing device 300, a notification indicating that the transmitter 100, the receiver 200, or both included in the WPT system 1 become in a predetermined condition, the second information processing device 400 presents, to a user, the result indicating that the transmitter 100, the receiver 200, or both included in the WPT system 1 become in the predetermined condition.

Additionally, the second information processing device 400 is capable of analyzing information relating to conditions of the transmitter 100 and receiver 200, accumulated in the first information processing device 300 and of presenting predetermined information to the user. The predetermined information includes, for example, as follows.
information on the arrangement of the transmitter 100
information on the arrangement of the receiver 200
information on the power consumption
information on the amount of electric power

### 1.1 Configuration of Transmitter and Receiver

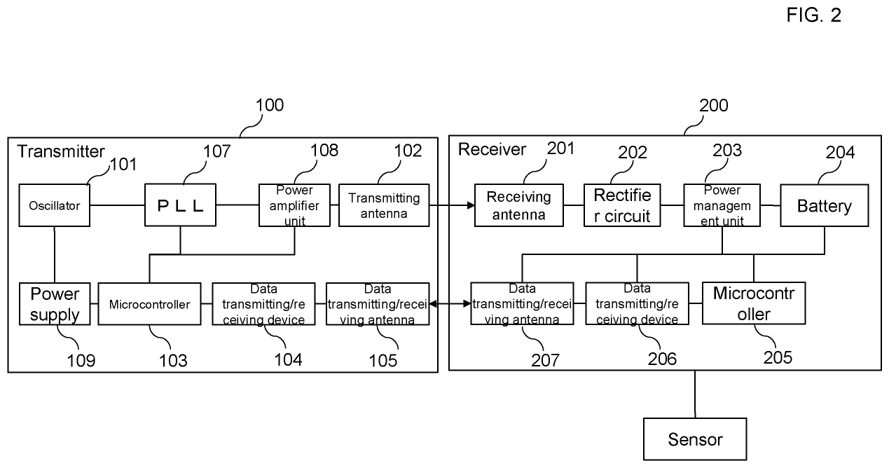

FIG. 2 is a block diagram illustrating an example of the configuration of the transmitter 100 and the receiver 200 illustrated in FIG. 1. As illustrated in FIG. 2, the transmitter 100 and receiver 200 are, for example, separated from each other at a predetermined interval. For example, the transmitter 100 and receiver 200 are installed to be separated from each other by a distance of approximately several meters. Specifically, for example, the transmitter 100 is fixedly installed at a high place in a building (for example, at a predetermined high position on a ceiling or a wall). The receiver 200 may be installed in a predetermined device in a building or placed in the vicinity of a device which is required to be fed with power. Also, the receiver 200 may be configured to be carried by a user. The transmitter 100 transmits power feeding signals to the receiver 200 by radio waves of a predetermined frequency, for example, in a frequency band of 920 MHz. The receiver 200 converts the power feeding signals transmitted from the transmitter 100 into electric power, and then charges the converted power or supplies the converted power to a predetermined device.

The transmitter 100 includes, for example, an oscillator 101, a transmitting antenna 102, a microcontroller (controller) 103, a data transmitting/receiving device 104, a data transmitting/receiving antenna 105, a capacitor, a PLL 107, a power amplifier unit (or power amplification unit) 108, a power supply 109, and a detector. For example, the whole or a part of a combination of the oscillator 101, the microcontroller 103, the data transmitting/receiving device 104, the data transmitting/receiving antenna 105, the capacitor, the PLL 107, the power amplifier unit 108, the power supply 109, and the detector may be mounted on a PCB (printed circuit board).

The oscillator 101 is configured to oscillate signals in a predetermined frequency band, for example, in a frequency band of 920 MHz. The oscillated signals may be amplified and unnecessary frequency components may be removed, according to the need.

The transmitting antenna 102 is configured to efficiently transmit radio waves, for example, in a frequency band of 920 MHz. The transmitting antenna 102 radiates the signals oscillated by the oscillator 101 as power feeding signals.

The microcontroller 103 is configured to control operations of the transmitter 100. The microcontroller 103 is realized by, for example, semiconductor elements having an ARM processor. The microcontroller 103 may be realized by using any integrated circuit such as GPIO, SPI, I2C, FPGA, DSP, or SoC. The microcontroller 103 is configured to control, for example, the transmission of radio waves from the transmitting antenna 102.

The data transmitting/receiving device 104 performs processes for example, a process of converting digital data into analog data and a process of modulating the analog data. Additionally, the data transmitting/receiving device 104 performs processes, for example, a process of demodulating data signals to be received by the data transmitting/receiving antenna 105 and a process of digitizing the demodulated data. The data transmitting/receiving device 104, for example, extracts predetermined signals from the data signals received by the data transmitting/receiving antenna 105, converts them into digital data, and transmits them to the microcontroller 103.

The data transmitting/receiving antenna 105 is configured to efficiently transmit and receive radio waves, for example, in a frequency band of 2.4 GHz. The data transmitting/receiving antenna 105 radiates data signals supplied from the data transmitting/receiving device 104. Additionally, the data transmitting/receiving antenna 105 receives data signals transmitted from the receiver 200.

The capacitor is provided between the PLL 107, the power supply 109, and the GND (ground, 0V), and is configured to serve as a bypass capacitor for generating high-quality signals.

The capacitor may be configured to be a capacitor which is connected to the PLL 107 in order to serve as a low-pass filter for generating high-quality signals and removing unnecessary high-frequency components. The low-pass filter includes a resistor and a capacitor, and is configured to be capable of directing high-frequency components to the capacitor and of passing through low-frequency components. By installing the low-pass filter between the oscillator 101 and the PLL 107, it is possible to remove unnecessary high-frequency components and to improve the quality of the output signals.

The PLL 107 is an electronic circuit known as the Phase-Locked Loop for controlling frequency and phase. A capacitor is connected to the PLL, and the frequency of radio waves to be transmitted from the transmitting antenna 102 is made to be changed according to the capacity of the capacitor. In the present embodiment, the capacitor is provided between the oscillator 101 and the PLL 107.

The power amplifier unit 108 is an electronic circuit capable of amplifying signals output from the PLL 107 based on power from the microcontroller 103 and of outputting them to the transmitting antenna 102.

The power supply 109 is a device capable of feeding electric power to the oscillator 101 and the microcontroller 103.

The detector is an electronic circuit capable of detecting intensity of radio waves transmitted from the transmitter 100.

Specifically, the detector is capable of detecting intensity of radio waves transmitted from the transmitter 100 by detecting electric power output from the power amplifier unit 108 to the transmitting antenna 102. Additionally, the detector may be configured as an electronic circuit that directly detects intensity of transmitted radio waves output from the transmitting antenna 102. In addition, the detector includes an arbitrary electronic circuit capable of directly or indirectly detecting intensity of radio waves transmitted from the transmitter 100.

The specific configuration of the detector will be described in more detail below with respect to the transmitter 100 (first embodiment) and the transmitter 100 (second embodiment).

The receiver 200 includes, for example, a receiving antenna 201, a rectifier 202, a power management unit 203, a power storage unit 204, a microcontroller 205, a data transmitting/receiving device 206, and a data transmitting/receiving antenna 207. For example, the whole or a part of a combination of the receiving antenna 201, the rectifier 202, the power management unit 203, the power storage unit 204, the microcontroller 205, the data transmitting/receiving device 206, and the data transmitting/receiving antenna 207 may be mounted on a PCB or FPC (flexible printed circuit board).

The receiving antenna 201 is configured to efficiently receive radio waves, for example, in a frequency band of 920 MHz. The receiving antenna 201 is configured to power feeding signals radiated from the transmitting antenna 102.

The rectifier 202 is configured to rectify radio waves to be received as the power feeding signals and to convert them into DC voltage.

The power management unit 203 is configured to manage DC voltages. For example, the power management unit 203 is configured control charging voltages based on DC voltages. The power management unit 203 charges the power storage unit 204 by controlling charging voltages. In addition, the power management unit 203 supplies DC voltages to a member which is connected thereto, for example, when electric power of a predetermined capacity or more is stored in the power storage unit 204.

In addition, the power management unit 203 is configured to release the power stored in the power storage unit 204 corresponding to the control of the microcomputer 205.

The power storage unit 204 is configured to store electric power therein in response to instructions from the power management unit 203. The power storage unit 204 is realized by, for example, a battery, a capacitor, or the like. In addition, the power storage unit 204 is configured to release the stored power in response to instructions from the power management unit 203.

The microcomputer 205 is configured to control operations of the receiver 200. The microcomputer 205 is driven by DC voltage supplied from the power management unit 203 or by electric power stored in the power storage unit 204. The microcomputer 205 is configured to control the power management unit 203 and to release the power stored in the power storage unit 204.

For example, it is possible to connect any of various types of sensors to the receiver 200. For example, it is possible to connect any one of the group consisting of a heat sensor, a temperature sensor, an optical sensor, a humidity sensor, a vibration sensor, and the like, to the receiver 200. For example, the sensor which is connected to the receiver 200 is driven by DC voltages supplied from the power management unit 203 or by electric power released from the power storage unit 204. The microcomputer 205 is capable of continuously or intermittently monitoring information such as voltage values at a predetermined portion of the receiver 200, conditions of a sensor connected to the receiver 200, and information detected by the sensor. The microcomputer 205 is capable of transmitting information such as voltage values at the predetermined portion of the receiver 200, conditions of the sensor connected to the receiver 200, and information detected by the sensor, to the data transmitting/receiving device 206, as digital data. In this example, the sensor may be included within the receiver 200.

The data transmitting/receiving device 206 is configured to perform processes, for example, a process of converting digital data to be supplied from the microcomputer 205 into analog data and a process of modulating the analog data. In addition, the data transmitting/receiving device 206 is configured to performs processes, for example, a process of demodulating data signals to be received at the data transmitting/receiving antenna 207 and a process of digitizing the demodulated data. The data transmitting/receiving device 206 is driven by, for example, DC voltages supplied from the power management unit 203 or by electric power released from the power storage unit 204.

The data transmitting/receiving antenna 207 is configured to be capable of efficiently transmitting and receiving radio waves, for example, in a frequency band of 2.4 GHz. The data transmitting/receiving antenna 207 radiates data signals which are supplied from the data transmitting/receiving device 206. In addition, the data transmitting/receiving antenna 207 receives data signals which are transmitted from the transmitter 100. For example, the data transmitting/receiving antenna 207 is driven by DC voltages supplied from the power management unit 203 or by electric power released from the power storage unit 204.

### 1.3 Operations of Transmitter 100

The operations of the transmitter 100 according to the present disclosure will be described as follows.

The transmitter 100 is capable of executing: a power detection step of detecting transmission power of the power feeding radio waves transmitted from the transmitter; and a power control step of controlling the transmission power so that the transmission power approaches a predetermined value, in a case that the transmission power detected in the power detection step does not match the predetermined value.

The power control step includes: a step of controlling the transmission power so that the transmission power reaches the predetermined value, in a case that the transmission power detected in the power detection step is lower than the predetermined value; and a step of controlling the transmission power so that the transmission power reaches the predetermined value, in a case that the transmission power detected in the power detection step is higher than the predetermined value.

Specifically, when detecting intensity of radio waves transmitted from the transmitter 100, the detector outputs it to the microcomputer 103. The microcomputer 103 controls electric power which is supplied to the power amplifier unit 108 from the power supply 109 in accordance with the detected value which has been input from the detector.

The control unit 103 controls the transmission power by controlling the input power to be input to the power amplifier unit based on the output of the detector so that the transmission power output from the power amplifier unit approaches the predetermined value.

The transmitter 100 is capable of executing: a comparison step of outputting a result of comparison between the transmission power detected in the power detection step and the predetermined value. The power control step is a step of controlling the transmission power so that the transmission power reaches the predetermined value based on the comparison result output in the comparison step.

The power control step is a step of controlling the input power to be input to the power amplifier unit so that the transmission power approaches the predetermined value in a case that the transmission power which is output from the power amplifier unit 108 and is detected in the power detection step does not match the predetermined value.

Specifically, the microcomputer 103 refers to a detected value detected by the detector and compares the detected value with a predetermined value. When the detected value is lower than the predetermined value, the microcomputer 103 increases power which is supplied to the power amplifier unit 108 from the power supply 109. After a predetermined period has elapsed (for example, after 5 milliseconds), the microcomputer 103 refers to the detected value detected by the detector again, and when the detected value is lower than the predetermined value, the microcomputer 103 increases the power which is supplied to the power amplifier unit 108 from the power supply 109. In this way, the microcomputer 103 increases the power to be supplied to the power amplifier unit 108 from the power supply 109 when the detected value is lower than the predetermined value.

Also, the microcomputer 103 refers to a detected value detected by the detector and compares the detected value with the predetermined value. When the detected value is higher than the predetermined value, the microcomputer 103 decreases power which is supplied to the power amplifier unit 108 from the power supply 109. In this way, the microcomputer 103 periodically refers to the detected value detected by the detector and carries out a control so that the power which is supplied to the power amplifier unit 108 from the power supply 109 is set approximately near to the predetermined value (or it falls within a predetermined range).

The microcomputer 103 may also compare a detected value with a specified value, and when the difference between the detected value and the specified value deviates by a predetermined value or more, the microcomputer 103 may carry out a control so that the power which is supplied to the power amplifier unit 108 from the power supply 109 approaches the specified value. Specifically, the microcomputer 103 increases or decreases the power which is supplied to the power amplifier unit 108 from the power supply 109 so as to be close to the specified value.

In this example, the detected value to be detected by the detector is the transmission power of the power feeding radio waves to be transmitted from the transmitter. And the transmission power of the power feeding radio waves is set to correspond to the power which is supplied to the power amplifier unit 108 from the power supply 109. Therefore, the power control step to be executed by the microcomputer 103 is carried out as a feedback control for keeping the transmission power of the power feeding radio waves transmitted from the transmitter within a predetermined range. More practically, the feedback control may be executed at predetermined intervals (periodically) of every 5 milliseconds. The period for executing the feedback control does not need to be 5 milliseconds and the feedback control may be executed in arbitrary periods (or cycles). The period for executing the feedback control may be set as a predetermined period according to the usage environment of the WPT system 1, the transmitter 100, the receiver 200, and the like. Also, the period for executing the feedback control may be determined according to the magnitude of the change in the detected value to be detected by the detector. For example, the feedback control may be executed at predetermined intervals only when the change in the detected value detected by the detector is equal to or more than a predetermined value, and the feedback control may not be executed when the change in the detected value detected by the detector is less than the predetermined value. In addition, the predetermined period may be set to be shorter as the change in the detected value detected by the detector becomes larger. Accordingly, it is possible to promptly control the power to be supplied to the power amplifier unit 108 from the power supply in response to the power fluctuations of the transmitter 100.

For the increasing width and decreasing width of the power to be supplied to the power amplifier unit 108 from the power supply 109, appropriate values are set according to the transmission power of the power feeding radio waves transmitted from the transmitter. The increasing width and decreasing width do not need to be fixed values, and different values may be set for them according to the usage environment of the transmitter 100. For example, the increasing/decreasing width may be set as a fixed value such as 1 dB, or the increasing/decreasing width may be made to be 3 dB when it is determined that an increase (or decrease) of 3 dB is required according to the detected value detected by the detector.

For example, it is preferable that the microcomputer 103 controls the power to be supplied to the power amplifier unit 108 so that the transmission power of the power feeding radio waves to be transmitted from the transmitter exceeds 1 W.

In addition, depending on laws and regulations, there are some cases where the transmission of radio waves of which intensity is equal to or more than a specified value is not permitted. In such cases, it is preferable that the magnitude of the decreasing width is set to be larger than that of the increasing width. By this, when the intensity of radio waves overshoots the target value, the intensity of the radio waves may be controlled with a large decreasing width.

In order to control the cycle (predetermined period) of the feedback control carried out by the microcomputer 103 and the increasing/decreasing width of the transmission power of the power feeding radio waves transmitted from the transmitter, a predetermined table or the like may be referred according to the usage environment such as the temperature of the substrate, and other external environments. Specifically, the microcomputer 103 may refer to a table (not shown) or the like according to sensing data such as the usage environment (for example, the temperature of the substrate, and other external environments) to calculate the cycle (predetermined period) of the feedback control, and the increasing/decreasing width of the transmission power of the power feeding radio waves transmitted from the transmitter.

In this example, the intensity of radio waves transmitted from the transmitter 100 does not necessarily need to be controlled based on the power which is supplies to the power amplifier unit 108 from the power supply 109. For example, the control may be carried out based on the whole or a part of a combination of the control of the PLL 107, an attenuator which is inserted between the PLL 107 and the power amplifier unit 108, and the gain control of the power amplifier unit 108.

The power detection step is a step of detecting the transmission power of the power feeding radio waves to be output from the power amplifier unit 108.

Specifically, the detector may be configured to indirectly detect the intensity of radio waves transmitted from the transmitter 100, by detecting power which is output to the transmitting antenna 102 from the power amplifier unit 108. The configuration of the detector will be described in more detail below with respect to the transmitter 100 (first embodiment) and the transmitter 100 (second embodiment).

### 2.1 Transmitter 100 (First Embodiment)

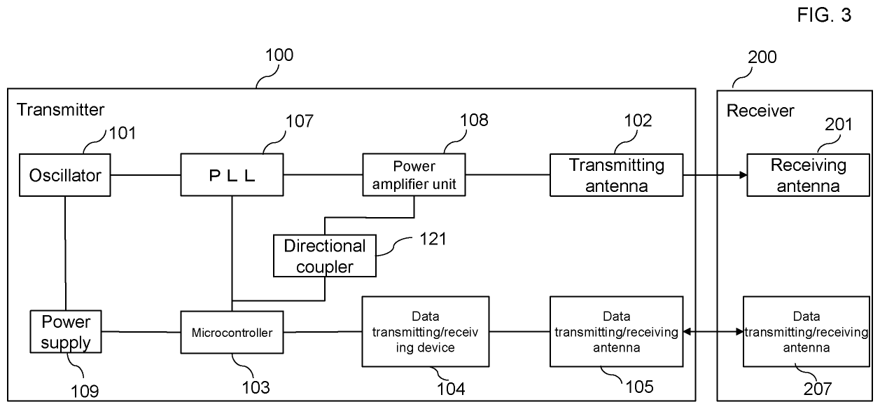

FIG. 3 is a block diagram illustrating an example of the configuration of the transmitter 100 (first embodiment).

The transmitter 100 (first embodiment) includes a directional coupler 121, a logarithmic detector, and an AD converter (ADC) in the transmitter 100 which has been already described. The other configurations are the same as those of the transmitter 100 which has been described in FIG. 2, and therefore the description thereof is omitted.

The directional coupler 121 is a circuit capable of extracting (or inserting) a part of signals on a certain transmission line from/to another transmission line. The directional coupler 121 is capable of extracting only signals having a specific directivity. The directional coupler 121 is superior to the below-mentioned wave detector 122 in that the output signals have a stability in characteristics to the temperature (or it has temperature dependence). Specifically, the directional coupler 121 is capable of outputting the same output signal with respect to the same input signal regardless of the temperature of the surrounding environment.

The logarithmic detector is a circuit capable of logarithmically detecting the amplitude of signals.

The AD converter is a circuit capable of converting analog signals into digital signals.

The directional coupler 121 is configured to output a part of output signals from the power amplifier unit to the detector.

Specifically, the directional coupler 121 is connected to the power amplifier unit 108. The directional coupler 121 is configured to divide power which is output to the transmitting antenna 102 from the power amplifier unit 108 to extract a part of the power.

The output of the directional coupler 121 is input to the logarithmic detector. The output of the logarithmic detector is input to the AD converter. And the output of the AD converter is input to the microcontroller 103.

For example, the directional coupler 121 divides power output from the power amplifier unit 108 and extracts a part of the power, and then outputs it to the logarithmic detector (Log Detector), which is one type of detector. The logarithmic detector outputs the input power as voltage or current values, as analog signals. The output of the logarithmic detector is input to the AD converter where it is converted into digital signals. The digital signals output from the AD converter are input to the microcontroller 103. In this example, the logarithmic detector is not essential and may be omitted.

### 2.2 Operations of Transmitter 100 (First Embodiment)

The operations of the transmitter 100 (first embodiment) in the present disclosure will be described below.

In the transmitter 100 (first embodiment), the microcontroller 103 executes a power control step of controlling the transmission power, based on the transmission power (detected value) detected from the directional coupler 121 via the logarithmic detector and the AD converter.

Specifically, the microcontroller 103 compares the detected value with a predetermined value. When the detected value is lower than the predetermined value, the microcontroller 103 increases the power to be supplied to the power amplifier unit 108 from the power supply 109. Also, the microcontroller 103 compares the detected value with the predetermined value. When the detected value is higher than the predetermined value, the microcontroller 103 decreases the power to be supplied to the power amplifier unit 108 from the power supply 109. Other operations of the transmitter 100 (first embodiment) are the same as the operations of the transmitter 100 which have been already described, and the description thereof is omitted.

### 3.1 Transmitter 100 (Second Embodiment)

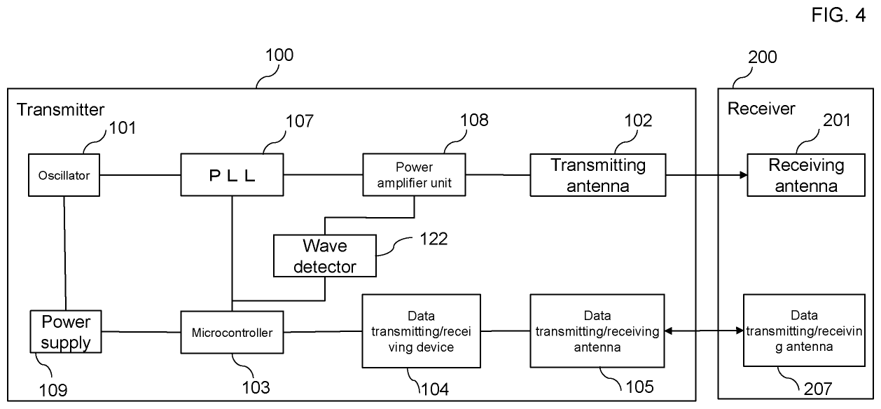

FIG. 4 is a block diagram illustrating an example of the configuration of the transmitter 100 (second embodiment).

The transmitter 100 (second embodiment) includes a wave detector 122, an AD converter (ADC), and a temperature measurement unit in the transmitter 100 which has been already described. The other configurations are the same as those of the transmitter 100 which has been described in FIG. 2, and therefore the description thereof is omitted.

The wave detector 122 is one type of electronic circuit capable of converting AC current or voltage values into DC values. The wave detector 122 may be used to detect the amplitude and/or frequency of radio waves at a time of performing wireless communication. The wave detector 122 may be used to measure power to be output to the transmitting antenna 102 from the power amplifier unit 108. For example, the detector is composed of a capacitor and a diode, and is configured to measure the power to be output to the transmitting antenna 102 from the power amplifier unit 108, by utilizing electromagnetic coupling with respect to the current to be output to the transmitting antenna 102 from the power amplifier unit 108.

The wave detector 122 includes a diode in the circuit, compared to the above-mentioned directional coupler 121, and as a result of that, the output signas are dependent on the temperature. Accordingly, there is a tendency that the output signals output from the wave detector 122 become different from the same input signal depending on the temperature of the surrounding environment. On the other hand, the wave detector 122 has the advantage of having a superior detection accuracy compared to the directional coupler 121.

The AD converter is the same as in the case of the transmitter 100 (first embodiment), and therefore description thereof is omitted.

It is preferable that the temperature measurement unit is a device capable of measuring the temperature of a substrate (PCB) on which a diode included in the wave detector 122 is provided. The temperature measurement unit may be a device capable of measuring the temperature around the wave detector 122. Also, the temperature measurement unit may be a device capable of detecting the temperature of the transmitter 100. The temperature measurement unit outputs information (signals) on the measured temperature to the microcontroller 103.

The wave detector 122 outputs a part of the output signals of the power amplifier unit to the detector.

Specifically, the wave detector 122 is connected to the power amplifier unit 108. The wave detector 122 measures the power to be output to the transmitting antenna 102 from the power amplifier unit 108.

The output of the wave detector 122 is input to the AD converter. And the output of the AD converter is input to the microcontroller 103.

### 3.2 Operations of Transmitter 100 (Second Embodiment)

The operations of the transmitter 100 (second embodiment) in the present disclosure will be described below.

In the transmitter 100 (second embodiment), the microcontroller 103 executes a power control step of controlling the transmission power, based on the transmission power (detected value) detected from the wave detector 122 via the AD converter.

Specifically, the microcontroller 103 compares the detected value with a predetermined value. When the detected value is lower than the predetermined value, the microcontroller 103 increases the power to be supplied to the power amplifier unit 108 from the power supply 109.

Also, the microcontroller 103 compares the detected value with the predetermined value. When the detected value is higher than the predetermined value, the microcontroller 103 decreases the power to be supplied to the power amplifier unit 108 from the power supply 109.

Other operations of the transmitter 100 (first embodiment) are the same as the operations of the transmitter 100 which have been already described, and the description thereof is omitted.

### Temperature Correction Process

Since the wave detector 122 has temperature dependency in its output characteristics, accurate feedback control may not be carried out if the detected value is used as it is. Hereinafter, the present disclosure describes a process for correcting temperature (temperature correction process) using the temperature measurement unit. In the transmitter 100 (second embodiment), the temperature correction process is not necessarily essential, but if such a temperature correction process is used, more accurate feedback control becomes possible.

The control unit 103 controls the input power to be input to the power amplifier unit based on the output of the detector which has been corrected based on the temperature measured by the temperature measurement unit.

The control unit 103 refers to a table in which coefficients are associated with temperatures, calculates a coefficient associated with the measured temperature in the table, with respect to the output value of the detector, to obtain a value, and controls the input power to be input to the power amplifier unit based on the obtained value. In this example, the coefficients may be associated with, in addition to the measured temperature, values relating to detected values such as detected transmission voltages and detected transmission powers. For example, it is possible to create the table based on a temperature characteristic data sheet relating to the inter-terminal voltages of the diode.

Specifically, the microcontroller 103 acquires information on temperature from the temperature measurement unit when referring to the detected value input from the detector. The microcontroller 103 refers to a table (not shown) in which temperatures and coefficients are stored in association with each other, while using the acquired temperature as a search key, in order to acquire a predetermined coefficient. Then the microcontroller 103 corrects the detected value by executing an arbitrary calculation such as multiplication, division, addition, and subtraction between the detected value and the predetermined coefficient, and accordingly obtains a corrected value of the detected value.

The microcontroller 103 does not necessarily need to refer to a table when acquiring a predetermined coefficient. For example, the microcontroller 103 may be configured to calculate a predetermined coefficient based on an arbitrary function, model, or the like in which the temperature is used as an argument.

The microcontroller 103 executes a power control step of controlling the transmission power based on the corrected value.

Specifically, the microcontroller 103 compares the corrected value with a predetermined value. When the corrected value is lower than the predetermined value, the microcontroller 103 increases the power to be supplied to the power amplifier unit 108 from the power supply 109.

Also, the microcontroller 103 compares the corrected value with the predetermined value. When the detected value is higher than the predetermined value, the microcontroller 103 decreases the power to be supplied to the power amplifier unit 108 from the power supply 109.

The feedback process to be executed at a time of performing the temperature correction process is the same as the feedback control in the transmitter 100 (second embodiment), except that the detected value is used as the corrected value.

Sensing data relating to usage environments and the like, which are used when the microcontroller 103 controls input power to be input to the power amplifier unit 108, include, for example, information indicating an internal or external environmental state of the transmitter 100 and information relating to a power receiving state acquired from the receiver 200. Specifically, the sensing data include, for example, any of the following:
RSSI information indicating received signal strength detected at the receiver 200
received power voltage information indicating a power receiving state of the receiver 200
operation state information indicating an operation state of the receiver 200
distribution information indicating arrangement or distribution conditions of a plurality of receivers 200

These sensing data may be acquired by various sensors provided in the transmitter 100, or may be acquired as information that is acquired by various sensors provided in the receiver 200 and then notified from a transmitting unit of the receiver 200 to the transmitter 100 by wireless data communication. For example, the transmitter 100 and the receiver 200 may mutually transmit and receive sensing data, control information, state information, and the like via communication radio waves using a frequency channel different from that of a high-frequency signal for power feeding. As such communication radio waves, for example, Bluetooth® or Wi-Fi®, or other wireless communication standards may be used. The microcontroller 103 of the transmitter 100 may control the transmission power by adjusting, based on at least one of these sensing data, correction of the output of the detector 123, the cycle of feedback control, or an increasing/decreasing width of the transmission power.

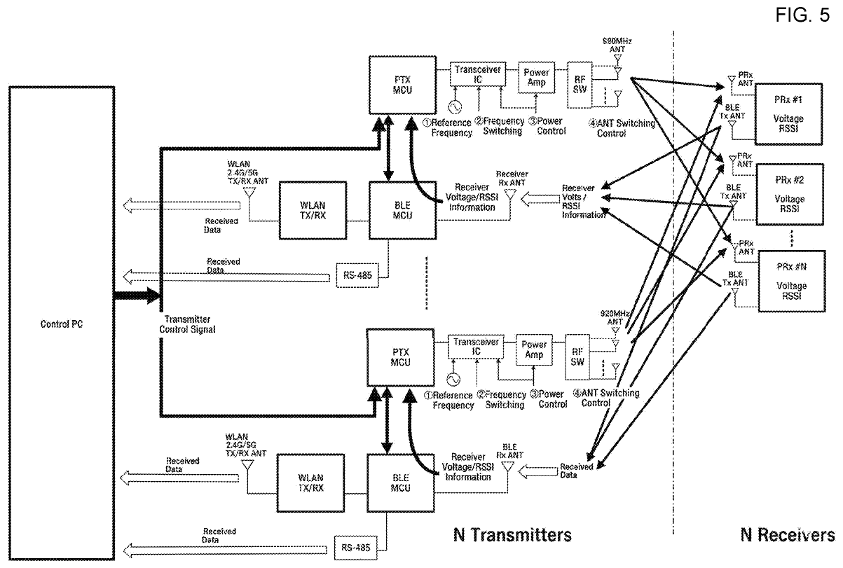

FIG. 5 is a diagram illustrating an example configuration of a transmission system according to a modification of the present invention. As shown in FIG. 5, in the transmission system according to the modification, a plurality of transmitters 100 (N Transmitters) and a plurality of receivers 200 (N Receivers) are arranged. Each transmitter 100 transmits power-feeding radio waves to a receiver through a power amplifier and a transmitting antenna, while also performing information communication with the receiver using communication radio waves on a frequency channel different from that of the power-feeding radio waves. For example, the transmitter 100 and the receiver 200 may each include a communication module based on a wireless communication standard such as Bluetooth® or Wi-Fi®, and may transmit sensing data, such as RSSI information, received-power voltage information, operating-state information, or distribution information acquired from the receiver, to the transmitter. The transmitter may also transmit control information to the receiver. In this manner, in the transmission system according to the modification, power transmission by the power-feeding radio waves and information communication by the communication radio waves are performed in parallel on different frequency channels, thereby enabling appropriate wireless power transfer control while exchanging sensing data and control information between the transmitter and the receiver.

### RSSI Correction Process

The transmitter 100 may acquire, as information indicating a power receiving state of the receiver 200, RSSI information indicating received signal strength detected at the receiver 200. The RSSI information is an index indicating received strength of the power feeding radio waves transmitted from the transmitter 100, and varies depending on the distance between the transmitter 100 and the receiver 200, the presence or absence of an obstacle, fluctuations in the surrounding environment, and the like.

In this modified example, an RSSI correction process using the RSSI information will be described below. RSSI information may alternatively be an index indicating the received signal strength of wireless communication radio waves transmitted from the receiver 200.

The microcontroller 103 corrects the output of the detector 123 based on the RSSI information acquired from the receiver 200. Then, the microcontroller 103 controls input power to be input to the power amplifier unit 108 based on the corrected output of the detector 123.

The microcontroller 103 refers to a table in which coefficients are associated with RSSI values, calculates a coefficient corresponding to the acquired RSSI value with respect to the output value of the detector 123, and controls the input power to be input to the power amplifier unit 108 based on a value obtained by the calculation. In this example, the coefficients may be associated, in addition to RSSI values, with values relating to detected values such as transmission voltages and transmission powers.

Specifically, the microcontroller 103 acquires RSSI information from the receiver 200 through communication based on a wireless communication standard such as Bluetooth® or Wi-Fi®. The microcontroller 103 uses the acquired RSSI value as a search key, refers to a table (not shown) in which RSSI values and coefficients are stored in association with each other, and acquires a predetermined coefficient. The microcontroller 103 corrects the detected value and obtains a corrected value of the detected value by executing an arbitrary calculation such as multiplication, division, addition, and subtraction between the detected value input from the detector 123 and the acquired coefficient.

The microcontroller 103 does not necessarily need to refer to a table when acquiring the predetermined coefficient. For example, the microcontroller 103 may be configured to calculate the predetermined coefficient based on an arbitrary function, model, or the like in which an RSSI value is used as an argument.

As used herein, a “table” is not necessarily limited to a tabular format, and may be any form of information in which a plurality of values are associated with each other.

The microcontroller 103 executes a power control step of controlling transmission power based on the corrected value.

Specifically, the microcontroller 103 compares the corrected value with a predetermined value. When the corrected value is lower than the predetermined value, for example, a minimum transmission power required to drive various sensors of the receiver, a transmission power corresponding to a target received voltage or target received power at which the receiver 200 can stably receive power, a reference transmission power preset at the time of designing the transmitter 100, or a transmission power control reference value set based on regulations such as radio laws or safety standards, the microcontroller 103 increases the power supplied from the power supply 109 to the power amplifier unit 108.

On the other hand, the microcontroller 103 compares the corrected value with the predetermined value. When the corrected value is higher than the predetermined value, the microcontroller 103 decreases the power supplied from the power supply 109 to the power amplifier unit 108.

The feedback control in the RSSI correction process is the same as the feedback control in the second embodiment except that the detected value is a corrected value corrected based on the RSSI information.

### Received Power Voltage Correction Process

The transmitter 100 may acquire, as information indicating a power receiving state of the receiver 200, received power voltage information detected at the receiver 200. The received power voltage information is an index directly indicating an electric power state actually acquired by the receiver 200 from the power feeding radio waves, and varies depending on the distance between the transmitter 100 and the receiver 200, the presence or absence of an obstacle, fluctuations in the surrounding environment, and the like.

The microcontroller 103 controls input power to be input to the power amplifier unit 108 based on the output of the detector 123 corrected based on the received power voltage information acquired from the receiver 200.

A correction process of the detected value based on the received power voltage information may be executed, similarly to the RSSI correction process, using a table in which coefficients are associated with received power voltage values or a function or model in which a received power voltage value is used as an argument. For example, the microcontroller 103 may use a received power voltage value acquired from the receiver 200 as a search key, refer to a table (not shown), and acquire a predetermined coefficient. The microcontroller 103 may correct the detected value and obtain a corrected value of the detected value by executing an arbitrary calculation such as multiplication, division, addition, and subtraction between the detected value input from the detector 123 and the acquired coefficient.

The microcontroller 103 executes a power control step of controlling transmission power based on the corrected value. The specific feedback control process is the same as the feedback control in the RSSI correction process. The microcontroller 103 compares the corrected value with the predetermined value, and when the corrected value is lower than the predetermined value, increases the power supplied from the power supply 109 to the power amplifier unit 108. On the other hand, when the corrected value is higher than the predetermined value, the microcontroller 103 decreases the power supplied from the power supply 109 to the power amplifier unit 108, thereby controlling the transmission power so that the transmission power approaches the predetermined value.

### Operation State Correction Process

The transmitter 100 may acquire operation state information notified from the receiver 200 as information indicating an operation state of the receiver 200. The operation state information is, for example, information indicating an operation mode such as whether the receiver 200 is in a start-up state, a charging state, or a standby state, and may be used as an index indicating a state of power demand in the receiver 200.

The microcontroller 103 controls input power to be input to the power amplifier unit 108 based on the output of the detector 123 corrected based on the operation state information acquired from the receiver 200.

A correction process of the detected value based on the operation state information may be executed, similarly to the RSSI correction process or the received power voltage correction process, using a table in which coefficients are associated with operation state information or a function or model in which operation state information is used as an argument. For example, the microcontroller 103 may use the operation state information acquired from the receiver 200 as a search key, refer to a table (not shown), and acquire a predetermined coefficient. The microcontroller 103 may correct the detected value and obtain a corrected value of the detected value by executing an arbitrary calculation such as multiplication, division, addition, and subtraction between the detected value input from the detector 123 and the acquired coefficient.

The microcontroller 103 executes a power control step of controlling transmission power based on the corrected value. The specific feedback control process is the same as the feedback control in the RSSI correction process and the received power voltage correction process. The microcontroller 103 compares the corrected value with the predetermined value, and when the corrected value is lower than the predetermined value, increases the power supplied from the power supply 109 to the power amplifier unit 108. On the other hand, when the corrected value is higher than the predetermined value, the microcontroller 103 decreases the power supplied from the power supply 109 to the power amplifier unit 108, thereby controlling the transmission power so that the transmission power approaches the predetermined value.

### Distribution Information Correction Process

The transmitter 100 may acquire distribution information of a plurality of receivers 200 as information indicating arrangement or distribution conditions of the plurality of receivers 200. The distribution information is, for example, information indicating positions, relative distances, arrangement density, or the number of existing receivers 200, and may be used as an index indicating how the power feeding radio waves transmitted from the transmitter 100 reach the plurality of receivers 200. When a plurality of receivers 200 are present, the transmission power of the transmitter 100 may be affected not only by the state of each receiver 200 but also by the arrangement or distribution conditions of the receivers 200 as a whole.

The controller 103 controls input power to be input to the power amplifier unit 108 based on the output of the detector 123 corrected based on the distribution information relating to the plurality of receivers 200.

A correction process of the detected value based on the distribution information may be executed, similarly to the RSSI correction process, the received power voltage correction process, or the operation state correction process, using a table in which coefficients are associated with the distribution information or a function or model in which the distribution information is used as an argument. For example, the microcontroller 103 may acquire distribution information based on position information, the number of existing receivers, or arrangement density of the plurality of receivers 200, use the distribution information as a search key, refer to a table (not shown), and acquire a predetermined coefficient. The microcontroller 103 may correct the detected value and obtain a corrected value of the detected value by executing an arbitrary calculation such as multiplication, division, addition, and subtraction between the detected value input from the detector 123 and the acquired coefficient.

The microcontroller 103 executes a power control step of controlling transmission power based on the corrected value. The specific feedback control process is the same as the feedback control in the RSSI correction process, the received power voltage correction process, and the operation state correction process, and the microcontroller 103 compares the corrected value with the predetermined value, increases the power supplied from the power supply 109 to the power amplifier unit 108 when the corrected value is lower than the predetermined value, and decreases the power supplied from the power supply 109 to the power amplifier unit 108 when the corrected value is higher than the predetermined value, thereby controlling the transmission power so that the transmission power approaches the predetermined value.

The various types of sensing data described above may be used alone or may be used in combination. For example, the transmitter 100 may acquire, in combination, a measured temperature measured by the temperature measurement unit and at least one of RSSI information, received power voltage information, and operation state information acquired from the receiver 200, and may correct the output of the detector 123 based on these pieces of information. In this case, the transmitter 100 may control the transmission power in consideration of the temperature state of the transmitter 100 and the power receiving state of the receiver 200.

Further, sensing data relating to a plurality of receivers 200 may be used in combination without using temperature information. For example, the transmitter 100 may acquire RSSI information and received power voltage information in combination and may correct the detected value in consideration of a reception state and a power receiving state. Further, the transmitter 100 may acquire RSSI information and distribution information in combination and may control the transmission power in consideration of arrangement conditions and reception states of the plurality of receivers 200.

Further, the transmitter 100 may acquire received power voltage information and operation state information in combination, estimate a state of power demand of the receiver 200, and reflect the estimated state in transmission power control. In this manner, by using a plurality of pieces of sensing data in combination, the transmitter 100 may execute transmission power control that more appropriately reflects a state of the transmitter 100, a power receiving state of the receiver 200, arrangement conditions of the receiver 200, and the like.

In the foregoing descriptions, a configuration has been described in which the microcontroller 103 corrects the output of the detector 123 based on predetermined sensing data and controls input power to be input to the power amplifier unit 108 based on the corrected value. However, the present disclosure is not limited thereto. For example, the microcontroller 103 may be configured to directly control input power to be input to the power amplifier unit 108 according to predetermined sensing data such as temperature information, RSSI information, received power voltage information, operation state information, or distribution information, without correcting the output of the detector 123. Specifically, the microcontroller 103 may refer to a table, function, model, or the like preset according to the sensing data, calculate an increase/decrease amount of input power to be input to the power amplifier unit 108 or a target input power, and control power supplied from the power supply 109 to the power amplifier unit 108 based on the calculation result. Even with such a configuration, the transmitter 100 may execute transmission power control in consideration of the usage environment of the transmitter 100 or the power receiving state of the receiver 200.

In the foregoing embodiments, a configuration has been described in which the microcontroller 103 controls transmission power based on predetermined sensing data, but the present disclosure is not limited thereto. For example, the microcontroller 103 may adjust transmission conditions of the transmitter 100 based on predetermined sensing data such as temperature information, RSSI information, received power voltage information, operation state information, or distribution information of a plurality of receivers 200. Specifically, the microcontroller 103 may adjust a reference frequency of the power feeding radio waves based on the sensing data. Further, the microcontroller 103 may execute frequency switching control for switching to one of a plurality of frequencies based on the sensing data. Further, when a plurality of transmitting antennas are provided in the transmitter 100, the microcontroller 103 may execute antenna switching control for switching a transmitting antenna to be used for transmission based on the sensing data. In this manner, by adjusting transmission conditions in addition to control of transmission power based on the sensing data, the transmitter 100 may realize appropriate wireless power feeding according to the power receiving state, arrangement conditions, usage environment, and the like of the receiver 200.

For example, when reference frequency adjustment is performed using temperature information as an input, circuit characteristics of the antenna, matching circuit, or power amplifier unit 108 of the transmitter 100 may vary due to temperature changes, and resonance conditions or impedance matching conditions of the power feeding radio waves may change. In such a case, the microcontroller 103 can suppress a decrease in power transmission efficiency between the transmitter 100 and the receiver 200 by adjusting the reference frequency of the power feeding radio waves. In this manner, the transmitter 100 can suppress fluctuations in power feeding efficiency caused by temperature changes and can realize stable wireless power feeding.

Further, when switching of a transmitting antenna is performed using RSSI information as an input, if received signal strength detected at the receiver 200 falls below a predetermined value, the microcontroller 103 can improve a receiving state at the receiver 200 by switching from one of a plurality of transmitting antennas to another transmitting antenna. In this manner, the transmitter 100 can adaptively respond to degradation in reception quality due to the presence of an obstacle, a change in the position of the receiver 200, and the like, and can realize stable transmission of the power feeding radio waves. Further, even when radio wave interference caused by power feeding radio waves from another transmitter 100 occurs in an environment in which a plurality of transmitters 100 are present, the influence of the radio wave interference can be reduced by switching the transmitting antenna according to the receiving state.

Further, when switching of a transmitting antenna is performed using distribution information of a plurality of receivers 200 as an input, the microcontroller 103 can efficiently transmit the power feeding radio waves to the plurality of receivers 200 by switching the transmitting antenna used for transmission according to positions, arrangement density, or relative distribution conditions of the plurality of receivers 200. In this manner, the transmitter 100 can improve power supply efficiency for the receivers 200 as a whole even in an environment in which the plurality of receivers 200 are present.

Further, when frequency switching control is performed using received power voltage information as an input, if the received voltage detected at the receiver 200 falls below a predetermined value, the microcontroller 103 can select a frequency condition having high power transmission efficiency between the transmitter 100 and the receiver 200 by switching to another frequency among a plurality of frequencies. In this manner, the transmitter 100 can optimize the frequency of the power feeding radio waves according to the power receiving state at the receiver 200 and can realize efficient wireless power feeding. Further, even when a plurality of transmitters 100 are arranged in the same space and transmit power feeding radio waves, radio wave interference with power feeding radio waves transmitted from another transmitter 100 can be avoided or reduced by switching the frequency of the power feeding radio waves.

In the present disclosure, a “transmission system” means a device or a group of devices having a function of transmitting power feeding radio waves to a receiver. The transmission system may be configured as a transmitter alone, or may be configured as a system including a transmitter and at least one receiver that receives power feeding radio waves transmitted from the transmitter. Further, the transmission system may include a plurality of transmitters and/or a plurality of receivers, and may further include a communication device, a control device, a management device, or the like that communicates control information or sensing data between the transmitter and the receiver. That is, the “transmission system” in the present disclosure is used as a concept including not only a device configuration of the transmitter alone but also an overall configuration of a wireless power feeding system including a transmitter and a receiver.

### Postscript

For the matters described in the respective embodiments, additional comments are given below.

### (Configuration 1)

A transmitter (100) is configured to be capable of wirelessly feeding power to at least one receiver (200) through power feeding radio waves. Wherein the transmitter (100) is capable of executing: a power detection step of detecting transmission power of the power feeding radio waves transmitted from the transmitter; and a power control step of controlling the transmission power so that the transmission power approaches a predetermined value, in a case that the transmission power detected in the power detection step does not match the predetermined value. With this configuration, the transmission power of the power feeding radio waves output from the transmitter may be controlled so as to close to the predetermined value. Accordingly, power suitable for operating the receiver may be transmitted to the receiver.

### (Configuration 2)

The transmitter (100) according to configuration 1 may be configured to be capable of executing a comparison step of outputting a result of comparison between the transmission power detected in the power detection step and the predetermined value. Wherein the power control step is a step of controlling the transmission power so that the transmission power approaches the predetermined value based on the comparison result output in the comparison step.

With this configuration, the transmission power of the power feeding radio waves transmitted from the transmitter may be controlled so as to close to the predetermined value.

### (Configuration 3)

The transmitter (100) according to configuration 1 or 2 may be configured to comprise a controller (103) and a power amplifier unit (108). Wherein the power detection step is a step of detecting the transmission power of the power feeding radio waves output from the power amplifier unit (108). Wherein the power control step is a step in which the controller (103) controls input power supplied to the power amplifier unit (108) so that the transmission power approaches the predetermined value, in a case that the transmission power which is output from the power amplifier unit and is detected in the power detection step does not match the predetermined value.

With this configuration, the transmission power of the power feeding radio waves transmitted from the transmitter may be controlled so as to close to the predetermined value.

(configuration 4)

The transmitter (100) according to any one of configurations 1 to 3 may be configured to comprise a controller (103), a power amplifier unit (108), a directional coupler (121), and a detector. Wherein the directional coupler (121) outputs a part of output signals of the power amplifier unit (108) to the detector. Wherein the controller (103) controls the transmission power so that the transmission power output from the power amplifier unit approaches the predetermined value, by controlling input power input to the power amplifier unit based on an output of the detector.

With this configuration, since the directional coupler does not have temperature dependence, and accordingly, the transmission power may be controlled to be appropriate power without depending on temperature.

### (Configuration 5)

The transmitter (100) according to any one of configurations 1 to 3 may be configured to comprise a controller (103), a power amplifier unit (108), a wave detector (122), and a detector. Wherein the wave detector (122) outputs a part of output signals of the power amplifier unit (108) to the detector. Wherein the controller (103) controls the transmission power so that the transmission power output from the power amplifier unit approaches the predetermined value, by controlling input power input to the power amplifier unit based on an output of the detector.

With this configuration, since the wave detector has a superior detection accuracy compared to a directional coupler, the transmission power may be controlled to be appropriate power, more accurately.

### (Configuration 6)

The transmitter (100) according to configuration 5 may be configured to comprise a temperature measurement unit. Wherein the controller controls input power input to the power amplifier unit based on an output of the detector, wherein the output is corrected based on a measured temperature measured by the temperature measurement unit.

With this configuration, the controller is capable of controlling the transmission power of radio waves transmitted from the transmitter based on the temperature measured by the temperature control unit, and accordingly, even in an environment that deviates from the standard temperature in the detector having temperature dependence, the transmission power may be appropriately controlled by the controller.

### (Configuration 7)

In the transmitter (100) according to configuration 6, the controller may be configured to refer to a table in which coefficients are associated with temperatures, to calculate a coefficient associated with the measured temperature in the table, with respect to the output value of the detector, to obtain a value, and to control input power to be input to the power amplifier unit based on the obtained value.

With this configuration, even in an environment that deviates from the standard temperature in the detector having temperature dependence, the transmission power may be appropriately controlled by the controller.

### (Configuration 8)

In the transmitter (100) according to any one of configurations 1 to 7, the power control step may be configured to comprise: a step of controlling the transmission power so that the transmission power reaches the predetermined value, in a case that the transmission power detected in the power detection step is lower than the predetermined value; and a step of controlling the transmission power so that the transmission power reaches the predetermined value, in a case that the transmission power detected in the power detection step is higher than the predetermined value.

With this configuration, the transmission power of the power feeding radio waves output from the transmitter may be controlled so as to close to the predetermined value. Accordingly, power suitable for operating the receiver may be transmitted to the receiver.

### (Configuration 9)

A wireless power feeding system comprising the transmitter according to any one of configurations 1 to 7, and the at least one receiver is also configured.

With this configuration, the transmission power of the power feeding radio waves output from the transmitter may be controlled so as to close to the predetermined value. Accordingly, power suitable for operating the receiver may be transmitted to the receiver.

1. A transmitter capable of wirelessly feeding power to at least one receiver through power feeding radio waves,
wherein the transmitter is capable of executing:
a power detection step of detecting transmission power of the power feeding radio waves transmitted from the transmitter; and
a power control step of controlling the transmission power so that the transmission power approaches a predetermined value, in a case that the transmission power detected in the power detection step does not match the predetermined value,
wherein the transmitter comprises a controller, a power amplifier unit, a wave detector, and a detector,
wherein the wave detector outputs a part of output signals of the power amplifier unit to the detector, and
wherein the controller controls the transmission power so that the transmission power output from the power amplifier unit approaches the predetermined value by controlling input power input to the power amplifier unit based on an output of the detector, and
wherein the controller controls input power input to the power amplifier unit based on the output of the detector corrected based on predetermined sensing data.

2. The transmitter according to claim 1, wherein the transmitter is capable of executing a comparison step of outputting a result of comparison between the transmission power detected in the power detection step and the predetermined value,
wherein the power control step is a step of controlling the transmission power so that the transmission power approaches the predetermined value based on the comparison result output in the comparison step.

3. The transmitter according to claim 1,
wherein the power detection step is a step of detecting the transmission power of the power feeding radio waves output from the power amplifier unit, and
wherein the power control step is a step in which the controller controls input power supplied to the power amplifier unit so that the transmission power approaches the predetermined value, in a case that the transmission power output from the power amplifier unit and detected in the power detection step does not match the predetermined value.

4.-6. (canceled)

7. The transmitter according to claim 1, wherein the controller refers to a table in which coefficients are associated with temperatures, calculates a coefficient associated with the measured temperature in the table, with respect to the output value of the detector, to obtain a value, and controls input power input to the power amplifier unit based on the obtained value.

8. The transmitter according to any one of claim 1, wherein the power control step comprises:
a step of controlling the transmission power so that the transmission power reaches the predetermined value, in a case that the transmission power detected in the power detection step is lower than the predetermined value; and
a step of controlling the transmission power so that the transmission power reaches the predetermined value, in a case that the transmission power detected in the power detection step is higher than the predetermined value.

9. (canceled)

10. The transmission system according to claim 1, wherein the transmitter further comprises a temperature measurement unit,
wherein the predetermined sensing data is a measured temperature measured by the temperature measurement unit, and
wherein the controller controls input power input to the power amplifier unit based on the output of the detector corrected based on the measured temperature measured by the temperature measurement unit.

11. The transmission system according to claim 1, wherein the predetermined sensing data is RSSI information indicating received signal strength detected at the receiver, and
wherein the controller controls input power input to the power amplifier unit based on the output of the detector corrected based on the RSSI information.

12. The transmission system according to claim 1, wherein the predetermined sensing data is received power voltage information detected at the receiver, and
wherein the controller controls input power input to the power amplifier unit based on the output of the detector corrected based on the received power voltage information.

13. The transmission system according to claim 1, wherein the predetermined sensing data is operation state information indicating an operation state of the receiver, and
wherein the controller controls input power input to the power amplifier unit based on the output of the detector corrected based on the operation state information.

14. The transmission system according to claim 1, wherein the predetermined sensing data is distribution information indicating arrangement or distribution of a plurality of the receivers, and
wherein the controller controls input power input to the power amplifier unit based on the output of the detector corrected based on the distrib
